(19) United States
(12) Patent Application Publication
(10) Pub. No.: US 2017/0323028 A1
(43) Pub. Date: Nov. 9, 2017

(54) SYSTEM AND METHOD FOR LARGE SCALE INFORMATION PROCESSING USING DATA VISUALIZATION FOR MULTI-SCALE COMMUNITIES

(71) Applicant: Uncharted Software Inc., Toronto (CA)

(72) Inventors: David Jonker, Toronto (CA); Scott Langevin, Toronto (CA)

(21) Appl. No.: 15/146,407

(22) Filed: May 4, 2016

(51) Int. Cl. G06F 17/30; G06F 3/0481; G06F 3/0484; G06F 17/22

(52) U.S. Cl. CPC G06F 17/30958; G06F 17/2235; G06F 3/0481; G06F 3/04847

(57) ABSTRACT

Processing node-link data comprising: obtaining the node-link data as a relational dataset having a plurality of nodes with inherent relationships between the nodes; generating a first level of the node-link data by aggregating the plurality of nodes into a plurality of first level communities and determining a respective first level relationship strength; generating a second level of the node-link data by aggregating the plurality of nodes into a plurality of second level communities and determining a respective second level relationship strength, each of the nodes in a first level community being assigned to only one of the plurality of second level communities; creating second level layout data by determining a relative visual size of each of the second level communities and determining a relative visual separation between each of the second level communities based; creating first level layout data by determining a relative visual size of each of the first level communities and determining a relative visual separation between each of the first level communities; assigning the first level layout data to a first data tile of a hierarchy of data tiles; assigning the second level layout data to a second data tile of the hierarchy of data tiles, the first data tile and the second data tile being in different levels of the hierarchy of data tiles; sending request data including the second data tile or the first data tile for use as a view of the node-link data for presentation on a graphical user interface of a user.

This application relates generally to multi-resolution data visualization of large data sets through data processing techniques.

### BACKGROUND

As scientists, government agencies, and businesses increasingly require insight from massive relational data sets approaching “web scale” (millions to billions of entity node and link relationships), there is a growing need for tools to create extensible visual graph analytics that help users understand relationships in big data. While computational algorithms can extract relational patterns from graph (node-link) data sets, they continue to lag behind the human ability to perceive visual patterns and anomalies. Interactive visual graph analytics are needed to facilitate discovery of nuances or patterns not typically identified by computational algorithms, and to assess the believability or perception of truth in answers computed with computational algorithms, and of information in the proper context. By exploring massive graph data in an interactive visual analytic system, users are able to apply their natural visual acuity to quickly identify clusters and communities of related nodes, understand how closely connected nodes suggest relationships and associations, and observe the structure of communities. This spatial representation of complex data facilitated by computational processes enables users to retain models of data organization and detect anomalies and patterns for further investigation.

However, creating visualizations for web-scale graph data has prohibitive perceptual and computational costs, such that traditional approaches often lack the capability to render massive data. Even when traditional approaches overcome limitations, the traditional approaches tend to produce overcrowded “hairball” renderings that obscure communities and have limited ability to support more detailed investigation. These rendering issues are especially detrimental to the understanding of relationships between entities. Knowledge of these structures is vital to understanding nodes and their relationship in highly related communities, internal and external node related topology, characteristics, and relational patterns. It is also recognized that traditional visualization approaches to community identification and graph layout algorithms applied to large graph data tend to deteriorate the ability to perceive and understand nuanced relationships between entities. Further, large-scale graph data sets pose challenges to existing visual graph analysis approaches, requiring new techniques to overcome the following issues. For example, computational performance issues (prohibitively expensive) are encountered in establishing optimal graph layouts that reveal node-link relationships.

Our investigation of existing graph layout methods focused on several different approaches, including treemap layouts, adjacency matrix layouts, and force-directed layouts. We concluded that few, if any, of the existing methods are scalable to large-scale graphs representing massive relational data sets. While force-directed layouts are designed to apply visual separation of unrelated nodes and minimize link crossings, they do not scale well with big data or ensure that nodes are aligned by identified relationship structure, as the position of each node is affected by the force of every other node in the graph, leading to expensive quadratic computational costs.

In terms of relationship clarity, separate relationship detection and graph layout processes can cause entity attributes and relationships to be lost or obscured. In terms of memory requirements, large graphs can be too big to fit in a memory of a single machine. In terms of rendering performance, rendering graphs can exceed millions of nodes and links and as such can be undesirably time consuming.

### SUMMARY

The systems and methods as disclosed herein provide a data processing and visualization technique for large data sets to obviate or mitigate at least some of the above presented disadvantages.

A first aspect of is a method for processing node-link data, the method comprising the steps of: obtaining the node-link data as a relational dataset having a plurality of nodes with inherent relationships between the nodes; generating a first level of the node-link data by aggregating the plurality of nodes into a plurality of first level communities and determining a respective first level relationship strength between each of the plurality of first level communities, each respective first level relationship strength based on links between the nodes in a respective first level community and the nodes in a different first level community; generating a second level of the node-link data by aggregating the plurality of nodes into a plurality of second level communities and determining a respective second level relationship strength between each of the plurality of second level communities, each respective second level relationship strength based on links between the nodes in a respective second level community and the nodes in a different second level community, each of the nodes in a first level community being assigned to only one of the plurality of second level communities, said being assigned for each of the nodes representing child-parent relationships defining a community hierarchy; creating second level layout data by determining a relative visual size of each of the second level communities based on a quantity of the nodes contained therein and determining a relative visual separation between each of the second level communities based on the respective second relationship strengths; creating first level layout data by determining a relative visual size of each of the first level communities based on a quantity of the nodes contained therein and determining a relative visual separation between each of the first level communities based on the respective first relationship strengths; assigning the first level layout data to a first data tile of a hierarchy of data tiles; assigning the second level layout data to a second data tile of the hierarchy of data tiles, such that the second data tile contains the second level layout data of a lower resolution of the node-link data than first level layout data of the first data tile, the first data tile and the second data tile being in different levels of the hierarchy of data tiles; sending request data including at least one of the second data tile or the first data tile for use as a view of the node-link data for presentation on a graphical user interface of a user, wherein the system renders a visualization of the view to the graphical user interface; obtaining one or more user interactions from the user; and updating the content of the request data based on the user interactions.

A second aspect is a system for processing node-link data, the system comprising: a network interface for obtaining the node-link data as a relational dataset having a plurality of nodes with inherent relationships between the nodes; a tile generation engine for generating a first level of the node-link data by aggregating the plurality of nodes into a plurality of first level communities and determining a respective first level relationship strength between each of the plurality of first level communities, each respective first level relationship strength based on links between the nodes in a respective first level community and the nodes in a different first level community; the tile generation engine for generating a second level of the node-link data by aggregating the plurality of nodes into a plurality of second level communities and determining a respective second level relationship strength between each of the plurality of second level communities, each respective second level relationship strength based on links between the nodes in a respective second level community and the nodes in a different second level community, each of the nodes in a first level community being assigned to only one of the plurality of second level communities, said being assigned for each of the nodes representing child-parent relationships defining a community hierarchy; a layout engine for creating second level layout data by determining a relative visual size of each of the second level communities based on a quantity of the nodes contained therein and determining a relative visual separation between each of the second level communities based on the respective second relationship strengths; the layout engine for creating first level layout data by determining a relative visual size of each of the first level communities based on a quantity of the nodes contained therein and determining a relative visual separation between each of the first level communities based on the respective first relationship strengths; a tile generation engine for assigning the first level layout data to a first data tile of a hierarchy of data tiles; the tile generation engine for assigning the second level layout data to a second data tile of the hierarchy of data tiles, such that the second data tile contains the second level layout data of a lower resolution of the node-link data than first level layout data of the first data tile, the first data tile and the second data tile being in different levels of the hierarchy of data tiles; the network communication interface for sending request data including at least one of the second data tile or the first data tile for use as a view of the node-link data for presentation on a graphical user interface of a user, wherein the system renders a visualization of the view to the graphical user interface; the network communication interface for obtaining one or more user interactions from the user; and the network communication interface for updating the content of the request data based on the user interactions.

### BRIEF DESCRIPTION OF THE DRAWINGS

These and other features will become more apparent in the following detailed description in which reference is made to the appended drawings wherein:

FIG. 1 shows example data processing systems;

FIG. 2 is an example client and backend of FIG. 1;

FIG. 3 is an example configuration of the client of FIG. 1;

FIG. 4 is an example configuration of a community hierarchy of the systems of FIG. 1;

FIG. 5 is an example layout of communities of the hierarchy of FIG. 4;

FIG. 6 is a diagram of a pipeline staging of data processing for the systems of FIG. 1;

FIG. 7 is an example tile hierarchy of FIG. 1;

FIG. 8 is a further example of the tile hierarchy of FIG. 7;

FIG. 9 is an example configuration of the backend system of FIG. 1; and

FIG. 10 is an example operation of the systems of FIG. 1.

### DESCRIPTION

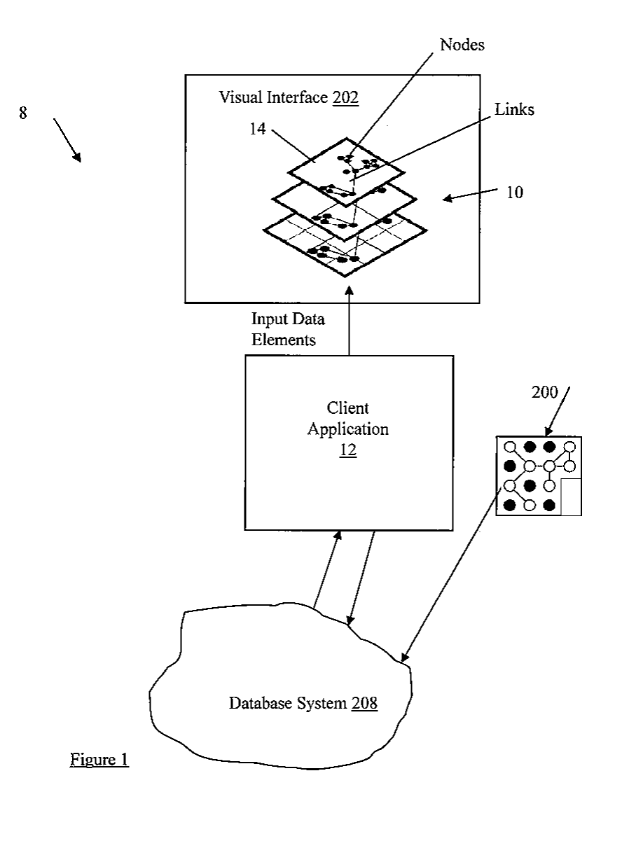

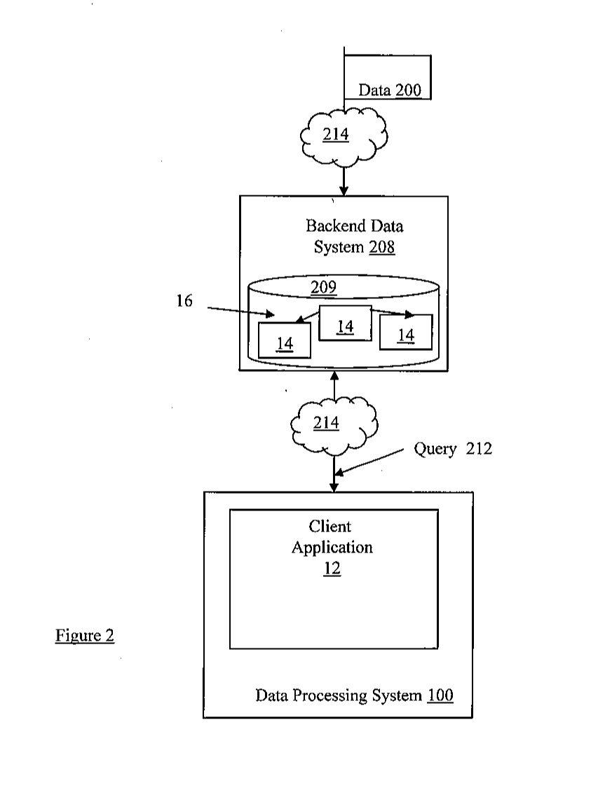

Referring to FIGS. 1, 2 and 3, shown is a visualization system 8 including a data processing system 100 (e.g. a computer that is a machine/device for manipulating data according to a list of instructions such as a program such as a client application 12) providing for visual investigation of an original data set 200 (e.g. a massive relational data set including a large number such as millions to billions of entity node and link/edge relationships), as displayed on a Visual Interface 202. The visualization tool 12 (e.g. client application) generates an interactive visual representation 10 on the visual interface (VI) 202 containing selected characteristics of the original data set 200. The system 100 communicates via queries 212 over a network 214 (e.g. an extranet such as the Internet), for example, with a backend system 208 (e.g. web based application), which stores the original data set 200 in a server storage 209 that is processed into a series of data tiles 14 organized in a tile hierarchy 16, as further described below. The original data set 200 can be stored both as raw data as well as processed data, as further described below. The original data set 200 can include large data sets involving data correlated over multiple dimensions as a relational data set of a node-link based format, including temporal dimensions as desired. For example, the original data set 200 can be used to represent social media data, e.g. group members (nodes) of a social media network and their interactions (links) with one another within the social media network, or e-commerce activities, e.g. consumers (nodes) of an e-commerce platform and their purchase habits (links), etc. As such, nodes can be defined as the entities in the graph data set 200. Links can be defined as pairwise relationships between the entities. Communities 220 can be defined as groups of nodes that have determined stronger inter-relationships to one another than to nodes not in the group. Sub-communities are reflected in that communities 220 are hierarchical, where the top-level 222 communities 220 refer to the highest organization of nodes and each next lower level 222 of communities 220 form sub-communities of their parent community 220. Inter-Community links can be defined as links between nodes with the same community 220. Intra-Community links can be defined as links between nodes that are not within the same community 220.

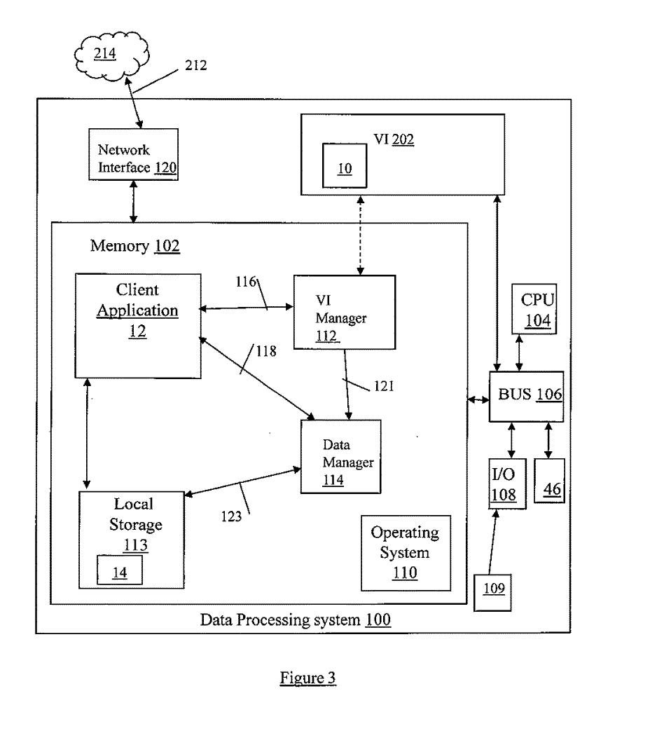

Nodes of the node-link data set 200 are aggregated into a community hierarchy 224 using a community generation engine 302, then a graph layout engine 304 is applied to spatially align nodes by community hierarchy 224. The resulting graph layout is summarized (e.g. aggregated extracted features) using a tile generation engine 306 across each of the levels of the tile hierarchy 16 (e.g. using a top down generation approach), where the raw nodes can be displayed. A tile service 308 returns rendered images of the tile 14 data or data objects to the visualization tool 12 in response to user interactions 109 (e.g. pan and zoom). Collectively this system is referred to as Graph Mapping. At each zoom level, nodes can be consistently sized relative to the screen pixel size to ensure clarity. Controls (via user interactions 109—see FIG. 3) facilitate users to alter visualization properties (e.g. changing node diameter or enabling information layers—described below) in order to adjust emphasis as requested for the visualization representation 12. Hierarchically clustering the raw data set 200 into a hierarchical data set 220 differentiates at every hierarchical level internal (intra-community) links—those between two nodes within the same cluster—from external (inter-community) links—those between nodes in different clusters. These links can be rendered as separate information layers for the requested tile 14 data, facilitating end users to tailor relative emphasis to support analytic interest. Links can be weighted in the tile 14 data to represent the strength of relationships between the nodes they connect, and can be visualized as a heatmap in the tile 14 data to depict strength, distribution and/or density of clusters of links. To inhibit visual clutter that can otherwise interfere with visibility of local connections, links leading to distant off screen nodes in the tile 14 data can be attenuated using opacity fall off.

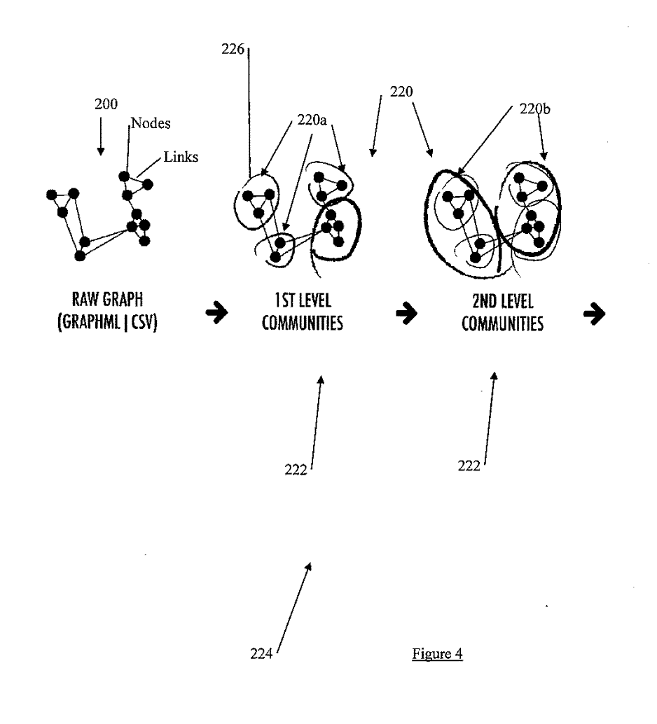

As shown in FIGS. 1, 7, 8, the interactive visual representation 10 using the tile hierarchy 16 can present tiles 14 in successive degrees of resolution (e.g. increasing/decreasing) as tile layers/levels, noting shown in FIG. 1 are multiple degrees of resolution (e.g. tile layers) at once for demonstration purposes only, as it is anticipated that the interactive visual representation 10 could have only one tile level displayed at a time for interpretation by the user of the client application 12. As such, distributed (e.g. cluster) computing of the system 8 provides for efficient generation of multi-resolution tiled datasets 16 with analytics and aggregate summaries information (optionally included) for each tile 14. Tiles 14 can be served by the backend system 208 and rendered by the client application 12 on demand (via client queries 212 requesting tiles by coordinate, level and information layer) as images or structured data objects for rendering in an interactive (e.g. web-based) client. The client application 12 provides users the ability to pan and zoom through increasingly detailed views of the source data 200, via user interactions 109 (see FIG. 3), processed and navigated as a “tile pyramid” 16 that spans global to local resolution scales of the source data 200, including aggregate views of the node-link data assembled into a series of communities 220 (see FIG. 4) organized in a community hierarchy 224, as further described below.

Labels can be included in the tile 14 data in order to add semantics to the display. Community labels can be derived hierarchically by the community generation engine 302 from the underlying child node attributes (e.g. node with highest sum of weights of incident links for a given node). Additional metadata for a community 220 (e.g. a distribution of its member node attributes) can also be derived and included in the tile 14 data. Further, tile-based analytics information can be included in the tile 14 data to express the character of communities 220. Additional tile-based analytics can be overlaid on top of the graph/representation 12. Each analytic information can summarize key attributes about the nodes or links underlying the corresponding tile 14. These overlays can summarize aspects with which to characterize visible communities 220, such as common topics of conversation shown as a word cloud, overviews of internal nodes and degrees, or community coordinates and radii.

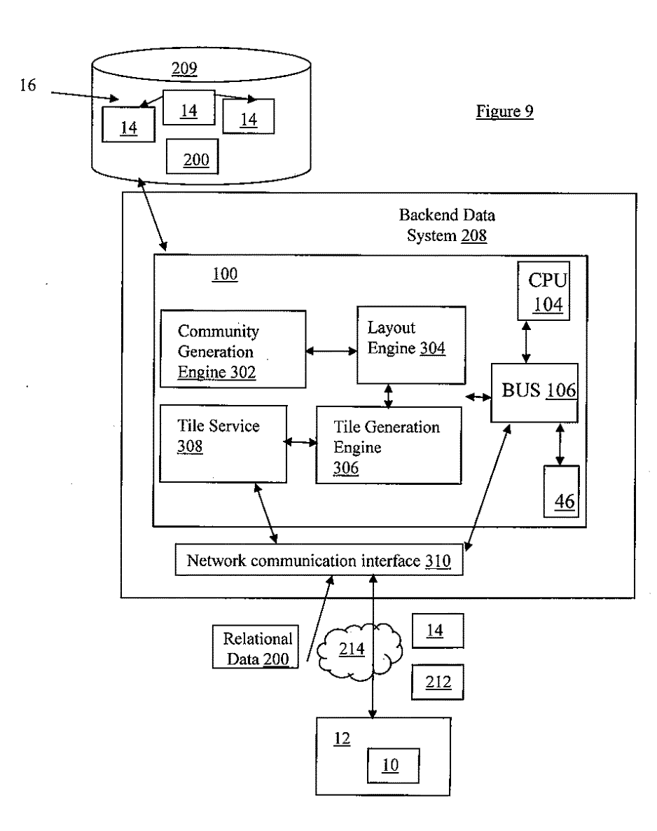

Operation of the client application 12 in conjunction with the back end system 208, using the graph mapping approach, addresses current prior art issues identified by applying an distributed (e.g. cluster) computing framework with a tile-based visual analytics methodology to: (1) identify and extract hierarchical communities 220 (via a community generation engine 302—see FIG. 9) in the raw graph data set 200 including groupings of the nodes based on their relationships to one another as exhibited by the corresponding links between the nodes; (2) apply a distributed layout algorithm (via a layout engine 304) to align nodes within their communities 220 (and communities 220 with respect to one another) according to their hierarchical 224 community membership and strength of respective link relationships; (3) optionally compute tile-based analytic summaries of community properties (via a tile generation engine 306); and (4) generate a multi-dimensional (e.g. two), interactive multi-scale graph visualization with a familiar, map-based web interaction scheme that supports intuitive pan and zoom navigation by rendering a set of tiles 14 (portraying differing levels of node-link resolution and features) organized in a tile hierarchy 16 (as generated by the tile generation engine 306). The tiles 14 would be sent in response to the user queries 212 by a tile service 308.

Referring again to FIG. 3, the data processing system 100 for producing the visualization representation 10 of the original dataset 200 has a user interface 108 for interacting with the client application 12, the user interface 108 being connected to a memory 102 via a BUS 106. The interface 108 is coupled to a computer processor 104 via the BUS 106, to interact with user events 109 to monitor or otherwise instruct the operation of the client application 12 via an operating system 110, in order to affect the data/visual content of the visualization representation 10. The user interface 108 can include one or more user input devices such as but not limited to a QWERTY keyboard, a keypad, a track wheel, a stylus, a mouse, and a microphone. The visual interface 202 is considered the user output device, such as but not limited to a computer screen display. If the screen is touch sensitive, then the display can also be used as the user input device as controlled by the processor 104. A network interface 120 provides for communication over the network 214 with the backend data system 208, if configured as separate systems coupled by the network 214. Further, it is recognized that the data processing system 100 can include a computer readable storage medium 46 coupled to the processor 104 for providing instructions to the processor 104 and/or the client application 12. The computer readable medium 46 can include hardware and/or software such as, by way of example only, magnetic disks, magnetic tape, optically readable medium such as CD/DVD ROMS, and memory cards. In each case, the computer readable medium 46 may take the form of a hard disk drive, solid-state memory card, or RAM provided in the memory 102. It should be noted that the above listed example computer readable mediums 46 can be used either alone or in combination.

Referring again to FIG. 3, the client application 12 interacts via link 116 with a VI manager 112 (also known as a visualization renderer) of the system 100 for presenting the visual representation 10 on the visual interface 202, along with visual elements representing the visual characterization of the original data set 200. The client application 12 also interacts via link 118 with a data manager 114 of the system 100 to coordinate management of a requested data set 200 (e.g. processed data available from the backend system 208 provided as one or more tiles 14) stored in a local memory 113. The tiles 14 represent the original data set 200 at varying resolutions of aggregated extracted features for subsequent rendering by the VI manager 112, as further described below. The data manager 114 can receive requests for storing, retrieving, amending, or creating the data content of the representation 10 via the client application 12 and/or directly via link 121 from the VI manager 112, as driven by the user events 109 and/or independent operation of the client application 12. Accordingly, the client application 12 and managers 112, 114 coordinate the processing of data content of the representation 10 and user events 109 with respect to the visual interface 202. It is recognised that the data manager 114 and/or VI manager 112 can be separate to, or part of, the client application 12 as configured in the memory 102.

Referring again to FIG. 9, the back end data system 208 can also have the data processing system 100 for producing the tiles 14 and tile hierarchy 16 based on the original dataset 200. The data processing system 100 can have the memory 209 connected to the BUS 106 and therefore coupled to the computer processor 104 via the BUS 106, to interact with monitor or otherwise instruct the operation of the various engines 302,304,306,308 via the operating system, in order to affect the data/visual content of the tiles 14. A network interface 310 provides for communication over the network 214 with the client application 12, if configured as to separate systems coupled by the network 214. Further, it is recognized that the data processing system 100 can include the computer readable storage medium 46 coupled to the processor 104 for providing instructions to the processor 104 and/or the various engines 302,304,306,308. The computer readable medium 46 can include hardware and/or software such as, by way of example only, magnetic disks, magnetic tape, optically readable medium such as CD/DVD ROMS, and memory cards. In each case, the computer readable medium 46 may take the form of a hard disk drive, solid-state memory card, or RAM provided in the memory 209. It should be noted that the above listed example computer readable mediums 46 can be used either alone or in combination.

The approach implemented in system 8 by the data processing system 100 in conjunction with the back end 208 creates interactive visualizations of massive node-link graph data sets 200 by employing tile-based visual analytics (including the community hierarchy distributed systematically over the tiles 14 in the tile hierarchy 16) to facilitate investigation using common web browsers (e.g. client application 12). The methodology can be as software built on Apache Spark and Hadoop. A cluster-computing and parallelization framework can generate multi-resolution tiled datasets (tiles 14 in the tile hierarchy 16) with analytics and aggregate summaries information (e.g. summaries of community node attributes) for each tile 14 as facilitated by the identified communities 220 (see FIG. 4) of nodes represented in the community hierarchy 224. Tiles 14 can be served by the back end system 208 and rendered by the client application 12 on demand as images in an interactive visualization representation 10. The client application 12 facilitates users to pan and zoom (via user interactions 109 delivered via the queries 212) through increasingly detailed views of the source data 200, the “tile pyramid” 16 that spans global to local scales. The tile generation process can use Apache Spark to convert character-delimited or GraphML source data 200 into the set 16 of structured data tiles 14 that summarize the individual data points (e.g. nodes and associated links) at multiple resolutions. The tile service 308 of the back end system 208 delivers the tiled data 14 to the web client application 12 (e.g. either as a set of image rasters or a JSON payload) for client-side rendering. Users can filter tile 14 views by attributes (via user interactions 109 delivered via the queries 212) such as time to apply visual metaphors on the fly. Analytic overlays (requested via user interactions 109 delivered via the queries 212) presented as overlay data in the tiles 14 can leverage the same underlying node-link data 200. Tile-based visual analytics can support cross-plot, geospatial, time series, and graph (node-link) representations (i.e. the visualization representation 10) of big data in the original data set 200.

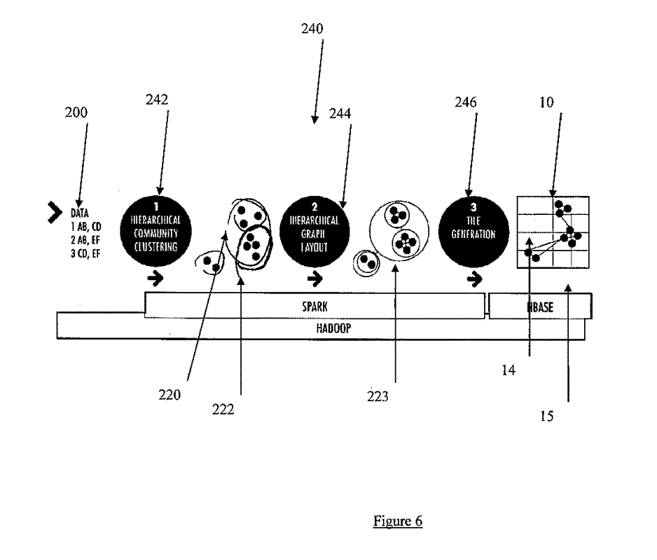

Detecting communities 220 (e.g. clustering, aggregating of nodes) of highly related nodes within the original data set 200 is important to revealing the structure of a graph topology subsequently portrayed as the visualization representation 10 of the data set 200, via the community generation stage 242 (see FIG. 6). Visually distinguishing communities 220 in the visualization representation 10 can highlight the relationships and commonalties among individual nodes. A community 220 can be defined as a group of nodes with more internal links (between the nodes of the identified community) as compared to exhibiting fewer external links (with nodes in other identified communities), thus forming well-connected subgraphs. Communities 220 visible in the current viewport and zoom level of the visualization representation 10 can be annotated via an information layer and treated as virtual nodes (e.g. having a bounding shape 226). For example, a group of nodes at one community level 222 in the community hierarchy 224 can be represented as a virtual node (i.e. community 220) in the next higher community level 222. These groups of nodes can be denoted by interactive circular boundaries around community members (i.e. nodes) and reveal additional metadata (i.e. label and summary analytic information) when selected. Each community 220 can be sized according to the number of member (e.g. child) nodes that the community 220 contains, or some other relative quantitative value as a parameter of the nodes. Zooming in on a community 220 via user interactions 09 can reveal its children, a group of closely connected sub-communities 220 and nodes. Further, the community 220 layout at each community level 222 in the community hierarchy 224 reflects centrality and importance in the node-link network as a whole. Fringe communities 220 can be plotted in a predefined layout pattern (e.g. spirally outside the centrally connected nodes) in the visualization representation 10 to illustrate separation from the rest of the network assembled into related communities 220.

Referring to FIG. 4, community 220a,b (referred to generically as communities 220) clustering/aggregating by the community generation engine 302 (see FIG. 9) iteratively groups related nodes in the dataset 200 (e.g. the relatedness of a pair of nodes determined by the strength/number of links between the pair of nodes) across numerous hierarchical levels 222 of a community hierarchy 224 by applying modularity maximization techniques, for example. It is recognised that the first level 222 is a child level of the second level 222 in the community hierarchy 224 (see FIG. 4), such that each of the community levels 222 can contain a plurality of respective communities 220. However, it is also recognised that the communities 220a of the first level 222 are contained within the communities 220b of the second level and so on up the community hierarchy 224, reflecting the child-parent relationship between the communities 220a,b of different community levels 222. As expected, each of the communities 220 can contain one or more nodes as determined by the clustering/aggregating algorithm to be dependent upon the degree of relatedness between the nodes based on their link strength. As noted, the community hierarchy 224 depicted has two example levels 222, such that by example the first level is a base level 222 of the community hierarchy 224 and the second level is a next level 222 at a node-link resolution lower than the node-link resolution exhibited by the first level 222. However, it is recognised that the community hierarchy 224 can have a plurality of levels organized into successive child-parent relationships (e.g. the first level communities 220a are children of the second level parent communities 220b and the second level as child communities 220b are children of third level communities 200 and so on). It is also noted that assembly of communities 220 from one level 222 to the next level 222 is such that a lower level 222 community 220 can only be resident in one community 220 in the next higher level 222, such that the communities 220 in each level are distinct (e.g. separated) from one another as visually depicted in the visualization representation 10. It is also recognised that any one node would be resident in only one community 220 at any given level 222 in the community hierarchy 224, however based on the child-parent relationship between communities at different levels 222 any particular node would also be resident in multiple communities 220 spread out across the levels 222 of the hierarchy 224. In other words, each node can be grouped into only one community 220 per level 222, however the node would be resident in a number of different communities 220 limited at one per level 222.

Accordingly, to detect and cluster/aggregate nodes that are highly connected (as represented by the strength/number of links between the nodes in the node-link data), the community generation engine 302 applies the aggregation algorithm to the source data 200 (e.g. using an Apache Spark GraphX library). Deemed highly connected nodes form the communities 220 at several different hierarchical levels 222, such that low-level communities 220 are detected from the raw data 200, those communities 220 are then aggregated accordingly at the next highest level 222 in the community hierarchy 224, and so on up the chain to the highest (global) hierarchical level 222 (i.e. representing the lowest visual resolution level of the data set 200 viewed by the visualization representation 10. Membership of an actual node in a particular community 220 depends on whether the aggregation algorithm, in analyzing the connectivity of links, deems the particular node to be related (e.g. similar) or not, to the other nodes in the community 220. For example, a pair of nodes having a number of individual links (communication, family relationships, organization relationships, age, gender, geography, etc. considered as intra-community links) between them could be considered as members in one community and a different pair of nodes having a number of different individual links between them could be considered as members in a different and separate community 220. The relationship (and degree thereof) between the two different communities 220 would be dictated by any links (considered inter-community links) between nodes of one community and nodes of the different community. As such, in analyzing the connectivity of links, the strength (e.g. number) of links dictates whether nodes belong in the same community 220 (visually depicted as all such nodes being within the bounding shape 226) and dictates the degree to which different communities 220 are related to one another (visually depicted as how spatially close the communities 220 are to one another in their common community level 222), as further described below in relation to operation of the community layout engine 304.

Bounding shapes 226 (e.g. circular, etc.) containing all of the nodes in a respective community 220 are sized (e.g. diameter of a circle, length of a perimeter of the shape, etc.) depending upon a measured quantity of the node contained in the community 220. For example, the measured quantity could be an actual number of nodes within the community 220, such that the size (e.g. diameter) of a bounding shape 226 for a community 220 with two nodes therein would be less than the size (e.g. diameter) of a bounding shape 226 for a community 220 with three nodes therein. The measured quantity could also be something other than number of nodes, for example reflecting a qualitative measure of each of the nodes (noting relative differences between nodes such as different node classifications—e.g. nodes of greater importance/class would contribute a larger quantitative portion to the size than nodes of a lesser importance/class).

As recognized, the community detection stage implemented by the community generation engine 302 is a factor in the scalability of the visualization representation 10 of the data set 200. If the node-link data set 200 can be hierarchically subdivided into an appropriate number of sub communities 220 within each parent community 220, the result can be both cognitively efficient for the analyst and computationally efficient for the remaining stages in generation of the visualization representation 10. For example, a “baseline” Louvain algorithm can be used as the aggregation algorithm, which was found to perform adequately (<20 minutes) and produce high modularity scores on all but the largest data sets (>10M nodes and 50M links). We also optimized visual comprehension of aggregation results for the nodes grouped into the communities 220 at each of the levels 222 by applying constraints to the baseline algorithm to limit community size (i.e. limits defined as to the number of nodes belonging to any one community 220).

We also modified the baseline algorithm to store metadata for each of the resulting communities 220, thereby providing descriptive statistics summarizing community 220 membership characteristics for the grouped nodes as metadata that can be included in the visualization representation as community labels, which facilitates user interactions with the visualization representation 10. For example, each community 220 is assigned by the community generation engine 302 a descriptive label representing the most central community member (i.e. node). Centrality can, for instance, be computed from the sum of the weights of incident links for a given node. Other community 220 metadata can be assigned using an aggregation function over all the child nodes.

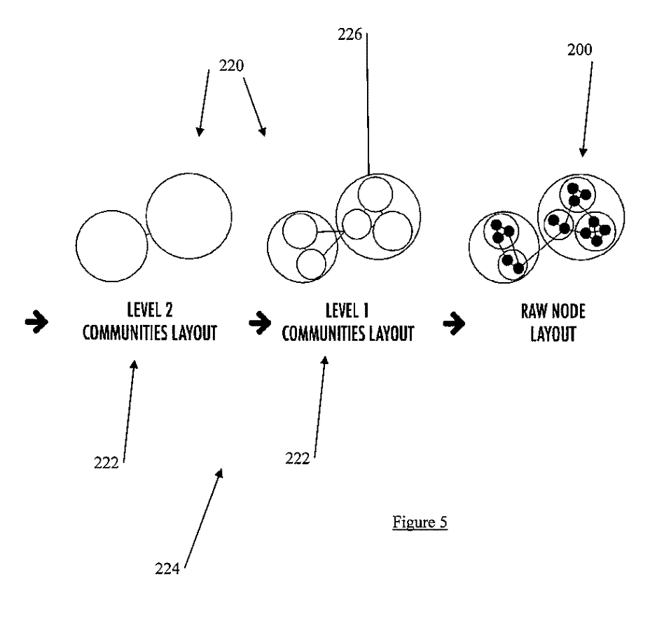

Referring to FIGS. 4 and 5, the community hierarchy 224 informs the graph layout engine 304, which positions communities 220 and nodes to convey relatedness spatially during the layout stage 244 (see FIG. 6), i.e. the spatial separation between adjacent communities 220 in any particular community level 222. The layout algorithm is applied hierarchically within the constraints of the parent community. Informed by the network and community structure, the Hierarchical Graph Layout stage positions nodes to convey relatedness through spatial proximity. For example, a force-directed algorithm can apply a modified Fruchterman-Reingold model to independently position graph elements (e.g. bounding shapes 226 representing a collection of nodes being members of the community 220 belonging to the bounding shape 226) across every level 222 in the hierarchy 224 for example from the top level down, preferably laying out the larger global communities 220 at higher levels independently of the lower-level structure/spacing and number of communities 220 contained therein. Each community 220 can be treated as a virtual node with a bounding shape size (e.g. radius) relative to the node quantity (e.g. number of nodes) the bounding shape 226 contains and arranged in proximity to other communities 220 with which it is connected via the inter community links. By utilizing the Apache Spark GraphX library, by example, lay out of the communities 220 on each hierarchy level 222 can be done in parallel. As shown in FIG. 5, our algorithm first lays out the most aggregated communities 220 at the top level 222 of the hierarchy 224. Once this is complete, the layout of the next lowest level 222 of communities 220 in the hierarchy 224 is done within the spatial constraints of the parent node on level 222, and so on. On each level 222, parallelization of the layouts of subcommunities 220 and nodes within each parent community 220 from the previous level 222 can be done to compute the overall global layout of the communities 220 on each level 222, thus providing that visual node proximity in the visualization representation 10 relates to the hierarchical community 220 structure in the hierarchy 224. It is recognized that the computed spatial distance between adjacent communities 220 in any particular level 222 can be a factor of the relative size and extent of adjacent bounding shapes 226 for each of the communities 220, based on the relative strength of intercommunity links between the nodes of the communities 220 of that level 222, etc.

To facilitate layout results and performance times generated by the layout algorithm, during each iteration of the algorithm, community 220 overlap is inhibited by accounting for community 220 extent (i.e. bounding shape size such as radii) during the force calculations. Once the whole layout converges, the final layout for each community 220 can be scaled appropriately to facilitate that the subcommunity 220 fits within the bounding area 226 of its parent community 220. Also at this stage, an anti-collision check can be performed to adjust the location of any nodes or communities 220 that overlap. To facilitate performance times, approximate calculation of the repellent forces can be done (e.g. using quadtree decomposition). A further option is to employ a scheme to adaptively “cool” or “reheat” the force-directed algorithm at each iteration depending on the amount of node movement, which can mitigates the tendency of the layout of the community level 222 to become stuck in a local minima state and thus more accurately detect when an ideal equilibrium is achieved.

The layout algorithm can also support optional features to fine tune the layout of the communities 220 at any given level 222. For example, the location of the node with the highest centrality score (e.g. the highest degree or PageRank) in each community 220 can be fixed in the center of the layout space of that community 220. This can make labelling in the visualization representation 10 more apparent and facilitate access by the user through requests to the most well-connected communities 220 and nodes thereof. In addition, link attraction forces (representing determined node membership within a community 220 as well as relationship (e.g. spatial distribution) of adjacent communities 220) can be scaled by weights to encode strength of node relationships. Finally, a gravitational force can be applied to each of the communities 220 can be used to attract communities 220 to the center of the layout and inhibit them from straying far outside the bounding shape 226 coordinates of their parent communities 220 to facilitate space-filling properties of the layout of the communities 220 at any given level 222.

A further option is where any communities 220 with a determined relatedness degree less than a specified threshold (i.e. for disconnected or very sparsely connected communities), these communities 220 can be laid out (i.e. spatially distributed in the space of the level 222) by the graph layout engine 304 in a fixed outer predefined shape (e.g. spiral) pattern separate from the inter-connected structure at the center of the graph. This technique can exclude these deemed disconnected communities 220 from the force-directed calculations to yield faster, more stable results while also visually separating isolated nodes (actual and/or virtual) from the main graph of communities 220 of a particular level 222.

As such, the algorithm as implemented by the graph layout engine 304 can determine separate statistics for the layouts on each hierarchical level 222, including the number of nodes and links and the minimum and maximum radii for the communities 220. Community cardinality can be proportional to geometric size, and can therefore indicate directly at which zoom levels (at which level in the tile hierarchy 16) each community 220 is reasonably visible.

Further, for example applying a recursive force-directed layout to community 220 layout in any particular level 222 of the community hierarchies 224 can inhibit the formation of hairballs by increasing visual separation between the communities 220 and distinguishing communities 220 and the relationships (e.g. inter community links) between them. On each level 222, the resulting magnitude of proximity between communities 220 can be used in the visualization representation 10 to visually indicate/reflect strength of relationship between the communities 220 of that level 222.

Accordingly, as noted above, the assembly of the communities 220 and community levels 222, via analysis of the link information in the node-link data set 200 by the community generation engine 302, operates in a bottom up approach such that the lowest level of the community hierarchy 224 is aggregated first into the communities 220 for the nodes and then the communities 220 in the higher levels 222 are generated while enforcing the child parent relationships between the communities 220 in the different levels as discussed. This generation of communities 220 in the community hierarchy 224 is performed on a level 222 by level 222 basis from hierarchy 224 bottom to top, e.g. from the first level 222 to the second level 222 for a two level community hierarchy 224, from the first level 222 to the second level 222 to the third level 222 for a three level community hierarchy 224, etc. This is in comparison to the operation of the graph layout engine 304, which operates in a top down approach such that the highest level 222 of the community hierarchy 224 is laid out first into the spatial distribution of the communities 220 for the nodes in that level 222 and then the communities 220 in the lower levels 222 are then laid out while utilizing the parent child relationships between the communities 220 in the different levels 22 to monitor the grouped and spatial relationships between the nodes in each of the levels 222. This generation of communities 220 layout in each level 222 of the community hierarchy 224 is performed on a level 222 by level 222 basis from hierarchy 224 top to bottom, e.g. from the second level 222 to the first level 222 for a two level community hierarchy 224, from the third level 222 to the second level 222 to the first level 222 for a three level community hierarchy 224, etc.

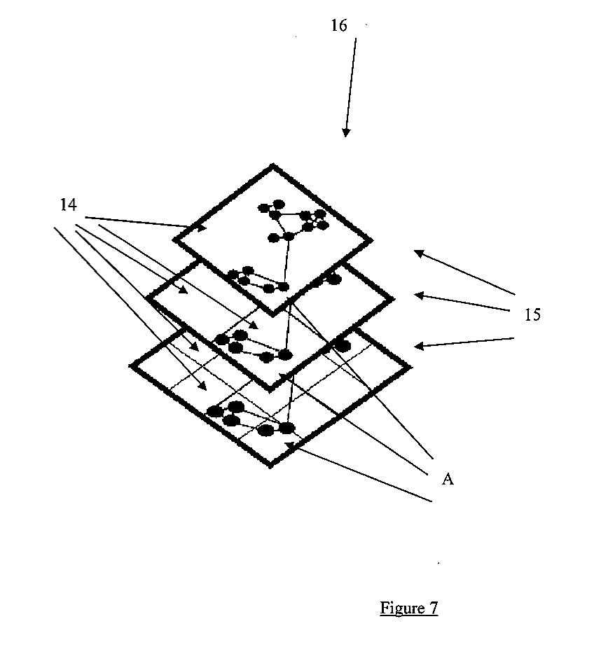

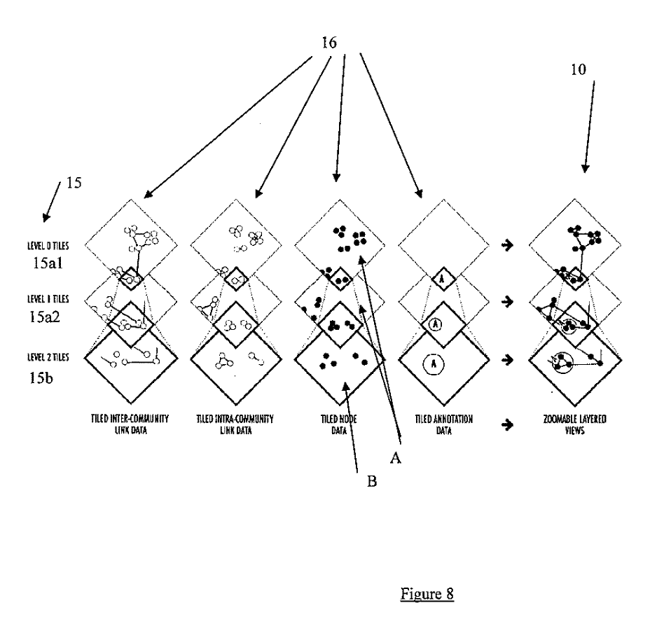

Referring to FIGS. 1 and 6, the web-based visualization service provided by the system 8 uses one or more image tile hierarchies (e.g. pyramids) 16 having one or more tiles 14 per hierarchy level 15 (see FIG. 7). It is recognized that the multi-tile levels 15 facilitate interactive multi-resolution navigation of the node-link data set 200 over the network 214. These tiles 14 aid users in viewing the node-link data set 200 at a global data resolution level and zooming down into more local data resolution views. It is recognized that the node-link data on the tiles 14, shown by example, represent the same communities 220 of the same community level 222 (see FIG. 5) but at differing resolution levels. It is also recognized that there can also be differing community hierarchy level(s) 222 assigned to different tile hierarchy levels 15 (e.g. see FIG. 8) for presentation to the client application 12, in order to satisfy the data presentation requests of the client application 12 to the back end system 208.

As such, it is recognised that one-to-one mapping between community hierarchy levels 222 and tile levels 15 is one embodiment. However, it is also recognised that there can be one-to-many mapping between community hierarchy levels 222 and tile levels 15 as another embodiment. for example, how to decide by the tile generation engine 306 on which community level 222 to use for a tile level 15 can be done in different ways. For example, it can be decided arbitrarily or determined via an algorithm. For example:
Pick an ideal community 220 size for visualization R_I (say, for the sake of argument, R_I=64 pixels)
For each hierarchy level H
   calculate the average radius R_H of the communities in H, in the cartesian space in which communities are laid out
for each tiling level T
   For each hierarchy level H, convert R_H from a raw cartesian coordinates, to a number of bins on level T, R_H_T
   Choose the hierarchy level H for which R_H_T is closest to R_I

It is recognised that there can be a single tile 14 per tile level 15 in the tile pyramid 16, or there can be many tiles 14 per tile level 15 in the tile pyramid 16.

These views of the visualization representation 10 containing the tiles 14 are served as dynamically rendered image tiles 14 sent to the client application 12 on-demand, based on the user's query requests sent to the back end system 208. It is recognized that pre-rendered graphic tiles may be sufficient for geographic map services, however pre-rendered graphic tiles are not ideal for visual analytic workflows using big data, where users need to be able to overview, zoom, filter, and expand details on demand during sense making. As shown in FIG. 8, having different graphical data content (of the node-link data set 200) represented in the tiles 14 (e.g. different link type data, different annotation data, and other layered views) is beneficial in interactive analysis of the node-link data set 200 as the user interprets and interacts with the visualization representation 10 via the user interface 108 (see FIG. 3).

Accordingly, the generalized tile-based approach of the present system 8 facilitates the ability to perform exploratory analysis on any large data set. The tile-based visual analytic (TBVA) approach provided by the tile hierarchy 16 incorporates aggregated node-link data 200 grouped into the community hierarchy 224 across multiple levels of resolution from a high-level “global” picture down to the individual data points, and also supports layering of information. However, instead of serving pre-rendered graphics, localized analytic summaries (i.e. for the current viewport by utilizing descriptive metadata associated with the various community hierarchy levels 222) are computed per tile 14 and served on request to the client application 12. This approach can be highly parallelizable, as each tile 14 region can be processed independently, producing aggregate views of the data contained within each tile 14 boundary as an offline batch process. Unlike static graphic tiles, tiled 14 data supports interactive analysis, such as filtering or applying new visual metaphors to the original data set 200. By utilizing web-based map interaction methods, a TBVA approach allows interactive exploration and drill down through familiar pan and zoom operations for the original data set 200 of the node-link data, leveraging the flexible visualization environment afforded by the generation, assignment and use of the community hierarchy levels 222 (and community 220 content laid out therein) with the tile hierarchy 16 construct. Creating a global “map” of all data facilitate consistency of location across levels of aggregation while progressively revealing more detail, enabling the user to learn areas of the data and maintain contextual perspective at all times. It is recognized that the tile-based visual analytics approach is generalizable to massive graph data sets.

As further described below, Graph mapping, the interactive visualization approach for massive graph data 200 as provided by the generation and use of the hierarchies 16, 224 employs tile-based visual analytics to enable hierarchical community 220 analysis in common web browsers (e.g. client application 12). The resulting visualization structure of the visualization representation 10 provides for multi-scale exploration/interaction of all the data set 200 content across a hierarchical community-based layout of nodes with layered in-context analytic summaries. To scale with massive data, this multi-stage methodology (see FIG. 6) builds on the distributed (e.g. cluster) computing platforms such as Apache Spark, GraphX and Hadoop by example, which facilitate efficient parallelization when computing hierarchical layouts and generating multi-scale tile-based views of the resulting graph layout. An HDFS-based key-value store (e.g. Apache HBase) can be used to enable distributed file storage and scalability to billions of tiles 14.

For example, in one embodiment, the graph mapping pipeline 240 uses Apache Spark to convert character-delimited or GraphML source data 200 into a set of serialized data tiles 14 that summarize the graph (i.e. node-link data content) at multiple resolutions. The graph mapping as implemented by the system 8 uses the pipeline 240 of community aggregating (by the community generation engine 302), graph layout (by the layout engine 304), and data tiling techniques (by the tiling engine 306) as further described below. The stages of hierarchical community generation 242 (as described above), hierarchical community layout 244 (as described above) and tile generation 246 (as described below) in the graph mapping pipeline 240 interoperate to generate an interactive, hierarchical visualization representation 10 of massive graph data 200. As shown by example in FIG. 6, a community hierarchy level 222 containing a series of communities 220 including layout information 223 (generated by the layout engine 304) is assigned to a series of tiles 14 in a tile level 15 of the tile hierarchy 16. It is recognized that, as discussed above, each of the community levels 222 can be distributed at differing data resolution levels across multiple tile levels 15 in the tile hierarchy 16, i.e. the same community hierarchy level 222 can be present at differing levels of resolution on adjacent multiple adjacent tile levels 15 (see FIG. 7 where community hierarchy A is on three different tile levels 15 albeit at different resolution levels). Further, it is recognized that different and separate community levels 222 are assigned to different successive tile levels 15, as the resolution requested increases or decreases as per the desired resolution level of the user, i.e. different community levels 222 in the community hierarchy 224 cannot be rendered on the same tile level 15 in the tile hierarchy 16 as different community levels 22 are inherently at differing data resolution levels due to the utilized parent-child relationship between the communities 220 on different community levels 222 (see FIG. 8 where community level A is on two tile levels 15a1,15a2, albeit at different resolution levels, while community level B is on a separate tile level 15b).

Once the tiles 14 are generated based on user request for specified data portions of the data set 200, the tile service 308 of the back end system 208 can deliver the tiled data to the web client application 12 (e.g. as either a set of rasters or a JSON payload) for client-side rendering based upon the zoom level and current viewport as desired by the user. This “tile pyramid” 16 representation of the graph (see FIGS. 7, 8) can span global to local scales, offering both aggregate views of the entire global level data and local-level depictions. The tile-based approach facilitates that a constant amount of data for display in the visualization representation 10 is transmitted to the client application 12, for example linear in the number of pixels in the client display 202 (see FIG. 3). As can be seen in FIGS. 7 and 8, tiles 14 of the tile hierarchy 16 represent massive graph data 200 at successive levels of detail to facilitate rapid interactive analysis by the user of the client application 12. It is also recognized that the tiles 14 are served and rendered on demand as images in an interactive web-based map client application 12, where users can pan and zoom through increasingly detailed views of the source data 200. Users can filter tile 14 views by attributes such as node degree or overlay analytics and aggregate summaries for each tile 14.

Referring to FIGS. 1,6 and 9, the tile generation stage 246 is performed, once the source graph data 200 is clustered/aggregated via stage 242 and the global layout is computed via the stage 244. In the tile generation stage 246, the positioned nodes and links as per the defined communities 220 of the community hierarchy 224 are passed to the Tile Generation engine 306 to create pyramids/hierarchies 16 of data tiles 14 that summarize the graph at multiple resolutions. Tiling 14 data, instead of static graphics, has an advantage of facilitating users to perform interactive data and visualization manipulation operations (e.g. pan, zoom, select filters, etc.) on the tile 14 data while viewing (i.e. via rendering) in the browser (e.g. client application 12). For example, color scales can be adjusted via interactions to better highlight variations in one part of the graph, or links below a certain weight may be filtered out.

As generated by the tile generation engine 306, each level 15 in the tile set pyramid 16 represents a hierarchical view of the entire force-directed layout of the graph data (FIG. 8). Individual tiles 14 on each level 15 correspond to specific subsets of the graph data and are further subdivided into bins (typically 256×256) that store the aggregated node or link information and optional metadata for that bin. At the highest level in the hierarchy (level 0), a single tile 14 can summarize the whole graph data. On each subsequent level 15 of the hierarchy 16, there can be 4z tiles, where z represents the “zoom” level. Massive graph tile pyramids 16 can be saved to an HDFS-based key-value store to enable distributed file storage, as particularly deep hierarchies (>10 levels) can result in millions of individual tiles. For example, a pyramid 16 with fourteen zoom levels can have 358 million tiles.

Referring again to FIG. 9, separate tile pyramids 16 can be generated for each of the graph elements (different node types, different link types, different labels, different analytic information, etc.), which users can dynamically combine via interactions to create custom layered visualizations representations 10 of the data set 200 represented in the tile 14 data. Drilling down on each level 15, by successively replacing one tile level 15 with another (e.g. next adjacent) tile level 15 in the visualization representation 10) can reveal increasingly detailed aggregate views until finally reaching a plot of all the raw data nodes on the lowest level of the hierarchy 16. It is recognised that the user can request 212 various portions (e.g. quadrants) of the whole data set 200 to work with in order to limit the amount/scope of the data set 200 represented in the tile 14 data rendered on the display.

It is noted that nodes and links and/or analytic and summary data of node-link features can be written to different tile 14 sets (e.g. hierarchies 16) so that they can appear as separate, filterable layers in the graph visualization 12. Separate tile sets 16 can also be created for inter-community and intra-community links. In each case, the raw data 200 can be passed through the pipeline (i.e. stages 242,244,246) that filters via the engines 302,304,306 for the appropriate data type (node, inter-community link, or intra-community link) and translates individual data into bins based on the location determined by the layout algorithm and the hierarchy levels 222,15. The values written to a bin (e.g. the link weights or the count of nodes or links) can then aggregated together to create a final value for use by the visualization pipeline. Each of the parsing, binning, and aggregation of node/link values stages can be run on a cluster using Apache Spark for efficient parallel execution. The resulting bins can be aggregated per tile 14 and stored in an HDFS-based key-value store, leveraging the node-link associated values assigned to each of the tiles 14 as per the inherent resolution defined in the community hierarchy 224 discussed (see FIG. 5).

When the graph tiling process is complete, the tile pyramid 16 can be served to the web client application 12, for rendering and subsequent interactive analysis. Each visual element type can be displayed as a separate layer that can be independently filtered or hidden, resulting in an interactive graph that can scale to a trillion or more “pixels” of resolution. Graph elements can be layered via the various tile hierarchies 16 to build a view of the relationships in a massive network (i.e. node-link data set 200) containing nodes, intra-community links, inter-community links, and communities 220 and labels.

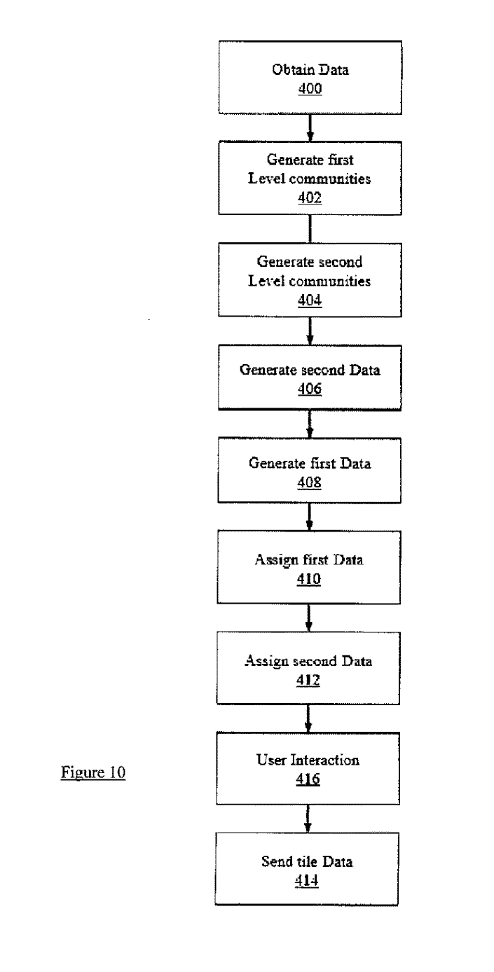

Referring to FIGS. 1, 3, 4, 9 and 10, shown is an example operation of the system 8 for processing node-link data 200. At step 400, obtaining the node-link data 200 as a relational dataset having a plurality of nodes with inherent relationships between the nodes. At step 402, generating a first level 222 of the node-link data 200 by aggregating the plurality of nodes into a plurality of first level communities 220 and determining a respective first relationship strength between each of the plurality of first level communities 220, each respective first relationship strength based on links between the nodes in a respective first level community 220 and the nodes in a different first level community 220. At step 404, generating a second level 222 of the node-link data 200 by aggregating the plurality of nodes into a plurality of second level communities 220 and determining a respective second relationship strength between each of the plurality of second level communities 220, each respective second relationship strength based on links between the nodes in a respective second level community 220 and the nodes in a different second level community 220. For example, each of the nodes in a first level community 220 being contained in only one of the plurality of second level communities 220 in a child-parent relationship defined by a community hierarchy 224. In other words, each of the nodes in the first level community 220 are assigned to only one of the plurality of second level communities 220 in order to represent child-parent relationships defining the community hierarchy 224. For example, such that if any pair of nodes are in the same first level community 220, then the same pair of nodes are in the same second level community 220.

At step 406, creating second data by determining a relative visual size of each of the second level communities 220 based on a quantity of the nodes contained therein and determining a relative visual separation between each of the second level communities 220 based on the respective second relationship strengths. At step 408, creating first data by determining a relative visual size of each of the first level communities 220 based on a quantity of nodes contained therein and determining a relative visual separation between each of the first level communities 220 based on the respective first relationship strengths. At step 410, assigning the first data to a first data tile 14 of a hierarchy 16 of data tiles. At step 412, assigning the second data to a second data tile 14 of the hierarchy 16 of data tiles, such that the second data tile 14 contains the second data of a lower resolution of the node-link data than first data of the first data tile 14, the first data tile 14 and the second tile 14 being in different levels of the hierarchy 16. At step 414, sending request data including at least one of the second data tile 14 or the first data tile 14 for use as a view of the node-link data for presentation on a graphical user interface of a user, wherein the user renders a visualization 10 of the request data to the graphical user interface. At step 416, obtaining one or more user interactions from the user and updating the content of the request data based on the user interactions and sending the updated request data to the user.

Tile-based visual analytics can offer a scalable solution to the challenges of creating massive graph visualizations by parallelizing and distributing the generation process. They can also offer a user experience that enables investigation of any subset of big data graph through efficient delivery of scale and context-appropriate data to the user interface. The community-based (e.g. force-directed) layouts, multi-resolution views and interactive labelling in the approach can address problems that persist in traditional hairball renderings of graph data. This combination of computational analytics with highly expressive interactive visualization can provide the opportunity for deeper understanding and trust. The tile-based approach (following the pipeline stages of 242,244,246) facilitates analysis of large-scale graphs. Presented are two examples that examine large data sets and offer qualitative results of how our visualization pipeline illustrates and informs community structures. Chelsea FC Fan Communities explores social media influence amongst individuals and organizations using the Twitter social network. Amazon Product Affinity uses the same real-world data set from our experimental analysis to map clusters of products that interest the same people.

For a real-world graph, we chose a Stanford-compiled Amazon Product Affinity data set 200, which was compiled from nine years of e-commerce activity. The Product Affinity data set included product metadata and review information from which reviewer nodes and review links were induced to complement the top five co-purchase product links (i.e. “customers who bought this also bought . . . ”). Nodes in the Amazon graph represent products and anonymized customers, while the links indicate weighted customer reviews and co-purchases. The layout of the Amazon data set in a resultant visualization 10 (following the pipeline stages of 242,244,246) suggested product affinity. The proximity of individual products and communities in the graph indicated that they appeal to the same consumers. Reviewing the hierarchical communities or related products can reveal social demographic data about customers. To generate synthetic small-world graph data sets, we used the Watts-Strogatz model, which puts N nodes into a K-wide lattice for a total of K*N links (we used K=6). The model then randomly decides whether to rewire each of them. To generate small and medium-sized synthetic scale-free graph data sets, we used the Barábisi-Albert model, which added nodes one at a time to an existing graph, adjoined a fixed number of links for each new node, and preferentially biased those links towards nodes that have a higher degree. Both of these models share properties of real-world networks.

The Chelsea FC Fan Communities application highlighted communities within the sphere of Twitter users who used Chelsea Football Club keywords in tweets during 2014. In total, the data set contained 248,747,072 tweets with 554,430 unique account nodes (users). The application contained 100,700 relationships (links) between users who have mentioned each other in tweets. Our first investigation of communities was location based. Chelsea FC data was mapped by geo-location. Directed, clockwise arcs between tweet locations indicated user mentions, while arc color indicated tweet density (e.g. dark blue for low density and white for high density). Geospatial mapping of Chelsea FC Twitter revealed connections between large communities in geographically diverse locations, such as England and West Africa. Word cloud overlays allowed quick cross referencing of trending topics both globally and regionally. These layouts of the Chelsea FC graph were determined by the structure of intercommunicating users, where intensity of directional arc links and the proximity of communities indicated the strength of the relationship between them. The graph layout of the Chelsea FC Twitter data revealed several details that the geospatial layout obscures. For example, a multitude of disconnected groups existed outside the core Twitter activity, indicating that they do not interact with the community at large.

The systems 100 introduce techniques for analysing massive amounts of data in the data set 200. The systems 100 can use image processing and data tiling techniques to allow the analyst to interact with the displayed data to help provide the visualization representation 10 that is responsive enough for real-time interaction with the massive data set 200. The systems 100 can be adapted to meet the need of computer analysts for dealing with the massive amounts of data for ultimately identifying patterns in a plethora of data in the original data set 200. This kind of recognition task is well suited to visualization: the human visual system is an unparalleled pattern recognition engine. The systems 100 facilitate the analyst to interactively explore an unprecedented amount of previously collected raw data (e.g. the original data set 200). Through the integration of database summarization and image processing techniques, the systems 100 can display a visualization representation 10 to help the analyst identify and examine patterns.

Accordingly, the above described method of processing node-link data set 200 and generating an interactive visualization 10 of the relational data spatially represent inherent relationships and summary analytics of the relational dataset. The method as outlined in the pipeline stages 242,244,246 and downstream rendering and interactivity can provide: Hierarchical community 220 extraction of highly connected nodes into community 220 and subcommunity 220 relationships; distributed iterative layout of nodes based upon the community hierarchy 16 to facilitate spatial proximity corresponding to hierarchical community 220 relationships amongst nodes; spatially layout the community hierarchy 16 at each level 15, for example so the node with the highest centrality score (e.g. the highest degree or PageRank) in each community 220 can be fixed in the center of the layout space of that community 220; simulated gravitational force that can be used to attract communities 220 to the center of the layout and inhibit them from straying far outside the bounding shape of their parent communities 220 to facilitate better space-filling properties of the layout graph; a tile-based visual analytic methodology to facilitate an interactive multi-scale visualization 10 of the graph layout produced; each level 15 in the tile pyramid 16 can represent a hierarchical data view of the entire layout of the graph that aggregates graph elements according to level 15,222 and divided into individual tile 14 regions according the tile pyramid level 15; separate tile pyramids 16 can be generated for each of the graph elements, which users can dynamically combine to create custom layered views of the tile 14 data, such as a heat map aggregation of nodes and links, aggregation of representative node labels, and community membership statistics; at each level 15,222, graph elements that are too difficult to discern (e.g. links to off-screen nodes, to lower levels of the community hierarchy, or between two very close endpoints) can be omitted from the display; and communities 220 visible in the current viewport and zoom level can be treated as virtual nodes as indicated visually by the bounding shapes 226 (e.g. they are denoted by interactive circular boundaries around community members and reveal additional metadata when selected); each community 220 is sized according to the node quantity selected (e.g. number of child nodes that it contains). Also discussed is the visual separation of disconnected or low degree nodes. For example, any communities 220 with a degree less than a specified threshold (i.e. disconnected or very sparsely connected communities), the layout engine 304 can lay out these disconnected communities 220 laid out in predefined (e.g. a fixed outer spiral) pattern separate from the inter-connected structure of the deemed connected communities 220 (i.e. with a degree greater than the specified threshold) at the center of the graph. Further, optionally the layout engine 304 can exclude these deemed disconnected communities 220 from the graph layout calculations to yield faster, more stable results while also visually separating isolated nodes from the main graph.

We claim:

1. A method for processing node-link data, the method comprising the steps of:
obtaining the node-link data as a relational dataset having a plurality of nodes with inherent relationships between the nodes;
generating a first level of the node-link data by aggregating the plurality of nodes into a plurality of first level communities and determining a respective first level relationship strength between each of the plurality of first level communities, each respective first level relationship strength based on links between the nodes in a respective first level community and the nodes in a different first level community;
generating a second level of the node-link data by aggregating the plurality of nodes into a plurality of second level communities and determining a respective second level relationship strength between each of the plurality of second level communities, each respective second level relationship strength based on links between the nodes in a respective second level community and the nodes in a different second level community, each of the nodes in a first level community being assigned to only one of the plurality of second level communities, said being assigned for each of the nodes representing child-parent relationships defining a community hierarchy;
creating second level layout data by determining a relative visual size of each of the second level communities based on a quantity of the nodes contained therein and determining a relative visual separation between each of the second level communities based on the respective second relationship strengths;
creating first level layout data by determining a relative visual size of each of the first level communities based on a quantity of the nodes contained therein and determining a relative visual separation between each of the first level communities based on the respective first relationship strengths;
assigning the first level layout data to a first data tile of a hierarchy of data tiles;
assigning the second level layout data to a second data tile of the hierarchy of data tiles, such that the second data tile contains the second level layout data of a lower resolution of the node-link data than first level layout data of the first data tile, the first data tile and the second data tile being in different levels of the hierarchy of data tiles;
sending request data including at least one of the second data tile or the first data tile for use as a view of the node-link data for presentation on a graphical user interface of a user, wherein the system renders a visualization of the view to the graphical user interface;
obtaining one or more user interactions from the user; and
updating the content of the request data based on the user interactions.

2. The method of claim 1, wherein the relative visual separation between each of the second level communities is independent of the relative visual separation between each of the first level communities.

3. The method of claim 1, wherein the respective second relationship strengths are second inter-community links based on an aggregation of links of the node-link data between the nodes in the respective second level community and the nodes in the different second level community, and the respective first relationship strengths are first inter-community links based on an aggregation of links of the node-link data between the nodes in the respective first level community and the nodes in the different first level community.

4. The method of claim 1, wherein the second level layout data is created such that each first level community is visually contained within said only one of the plurality of second level communities following said parent-child relationship.

5. The method of claim 1 further comprising said creating of the second level layout data and said creating of the first level layout data being implemented using a set of recursive layout instructions applied to both the plurality of second level communities and the plurality of first level communities.

6. The method of claim 5, wherein the set of recursive layout instructions follows a distributive and force directed determination of relative visual separation between each of the second level communities based on the second level relationship strengths and the set of recursive layout instructions follows a distributive and force directed determination of the relative visual separation between each of the first level communities based on the first level relationship strengths.

7. The method of claim 1 further comprising the step of filtering features of the node link data included in the request data according to the user interactions.

8. The method of claim 1, wherein said updating includes receiving said one or more user interactions as a display request for the first data tile of the hierarchy of data tiles; removing the second data tile from the display and displaying the first data tile containing the first level layout data.

9. The method of claim 1, wherein said updating includes receiving said one or more user interactions as a display request for the second data tile of the hierarchy of data tiles; removing the first data tile from the display and displaying the second data tile containing the second level layout data.

10. The method of claim 6, wherein the relative visual separation of the determined between each of the second level communities is independent of the relative visual separation determined between each of the first level communities, such that the relative visual separation between each of the second level communities is determined before the relative visual separation between each of the first level communities.

11. The method of claim 1, wherein said aggregating is performed for the first level communities before said aggregating for the second level communities.

12. The method of claim 1, wherein the relative community size is represented by a size of a bounding shape, the bounding shape used for each of the second level communities and the first level communities.

13. The method of claim 1, wherein the hierarchy of data tiles has a plurality of levels other than the levels of first data tile and the second data tile such that each level in the hierarchy of data tiles contains a higher resolution of the node-link data compared to the resolution of the node-link data of an adjacent data tile at a level higher in the hierarchy of data tiles.

14. The method of claim 13, wherein the resolution is consistent across all tiles within each level of the hierarchy of data tiles.

15. The method of claim 1, wherein intra-community links are links of the node-link data between the nodes within one of the communities and inter-community links are links of the node-link data between the nodes in different ones of the communities at a particular level in the community hierarchy.

16. The method of claim 1, wherein said quantity of the nodes represents a number of nodes contained in a community, such that each of the second level communities are a parent community to one or more of the first level communities.

17. The method of claim 1 further comprising the step of displaying a community label for each of the first level communities, such that each of the community labels being derived from the nodes of said each of the first level communities.

18. The method of claim 1, wherein the community hierarchy has a plurality of levels other than the levels of the first level communities and the second level communities such that each level in the community hierarchy is less aggregated as compared to the aggregation of the node-link data of an adjacent community level higher in the community hierarchy.

19. The method of claim 1, wherein the first data tile and the second data tile contain analytic and summary data extracted from features of the node-link data.

20. The method of claim 1, wherein each level of the hierarchy of data tiles contains a first tile set having a selected feature of the node link data and a second tile set having another selected feature of the node link data.

21. A system for processing node-link data, the system comprising:
a network interface for obtaining the node-link data as a relational dataset having a plurality of nodes with inherent relationships between the nodes;
a tile generation engine for generating a first level of the node-link data by aggregating the plurality of nodes into a plurality of first level communities and determining a respective first level relationship strength between each of the plurality of first level communities, each respective first level relationship strength based on links between the nodes in a respective first level community and the nodes in a different first level community;
the tile generation engine for generating a second level of the node-link data by aggregating the plurality of nodes into a plurality of second level communities and determining a respective second level relationship strength between each of the plurality of second level communities, each respective second level relationship strength based on links between the nodes in a respective second level community and the nodes in a different second level community, each of the nodes in a first level community being assigned to only one of the plurality of second level communities, said being assigned for each of the nodes representing child-parent relationships defining a community hierarchy;
a layout engine for creating second level layout data by determining a relative visual size of each of the second level communities based on a quantity of the nodes contained therein and determining a relative visual separation between each of the second level communities based on the respective second relationship strengths;
the layout engine for creating first level layout data by determining a relative visual size of each of the first level communities based on a quantity of the nodes contained therein and determining a relative visual separation between each of the first level communities based on the respective first relationship strengths;
a tile generation engine for assigning the first level layout data to a first data tile of a hierarchy of data tiles;
the tile generation engine for assigning the second level layout data to a second data tile of the hierarchy of data tiles, such that the second data tile contains the second level layout data of a lower resolution of the node-link data than first level layout data of the first data tile, the first data tile and the second data tile being in different levels of the hierarchy of data tiles;
the network communication interface for sending request data including at least one of the second data tile or the first data tile for use as a view of the node-link data for presentation on a graphical user interface of a user, wherein the system renders a visualization of the view to the graphical user interface;
the network communication interface for obtaining one or more user interactions from the user; and
the network communication interface for updating the content of the request data based on the user interactions.

22. The system of claim 21 further comprising said creating of the second level layout data and said creating of the first level layout data being implemented using a set of recursive layout instructions applied to both the plurality of second level communities and the plurality of first level communities.

23. The system of claim 22, wherein the set of recursive layout instructions follows a distributive and force directed determination of relative visual separation between each of the second level communities based on the second level relationship strengths and the set of recursive layout instructions follows a distributive and force directed determination of the relative visual separation between each of the first level communities based on the first level relationship strengths.
